(19) United States
(12) Patent Application Publication
(10) Pub. No.: US 2018/0087121 A1
(43) Pub. Date: Mar. 29, 2018

(54) LANCE FOR TOP INJECTION IN METALLURGICAL VESSELS AND PROCESS FOR MANUFACTURING SAME

(71) Applicant: VESUVIUS CRUCIBLE COMPANY, Wilmington, DE (US)

(72) Inventors: Martin Kreierhoff, Suedlohn (DE); Christian Warmers, Rhede (DE)

(73) Assignee: VESUVIUS CRUCIBLE COMPANY, Wilmington, DE (US)

(21) Appl. No.: 15/566,424

(22) PCT Filed: Apr. 14, 2016
(86) PCT No.: PCT/EP16/58179

§ 371 Date: Oct. 13, 2017

(30) Foreign Application Priority Data
Apr. 16, 2015 (EP) 15163822.8
Dec. 23, 2015 (EP) 15202638.1

(51) Int. Cl. C21C 5/46; F27B 3/22

(52) U.S. Cl. CPC C21C 5/4613; F27B 3/225

(57) ABSTRACT

A lance for top injection of a fluid in metallurgical vessels comprises an inner tube, a refractory sheath surrounding the inner tube, an anchoring point rigidly coupled to said inner tube and at least partially embedded in the refractory sheath, an annular gap separating the inner tube from the refractory sheath; at least one annular guide surrounding the inner tube and comprising: an annular portion circumscribing the inner tube, and at least two anchor protrusions rigidly extending transversally from the annular portion and at least partially embedded in the refractory sheath, wherein a guide gap is formed between the annular portion and an outer surface of the inner tube. The at least two anchor protrusions are distributed over the external surface of the annular portion, separated from one another by an angle comprised between 90° and 270°.

### BACKGROUND OF THE INVENTION

### (1) Field of the Invention

The present invention concerns a lance for injecting a fluid or solid particulate material into a metallurgical vessel suitable for the refining process of metals production such as pig iron, steel, or ferronickel. In particular, it concerns a lance having a specific design yielding a higher resistance to cracks formation caused by thermal gradients. The present invention also concerns a process for producing such lance.

### (2) Description of the Related Art

Metal production often requires injection of a fluid, generally a gas with or without solid particulate material, for example for refining process of pig iron and steel production. As illustrated in FIG. 1, an elongated lance is used to this purpose, with one end dipped in a molten metal (21) contained in a metallurgical vessel (20). A lance is generally composed of a hollow inner tube (1) made of metal, generally steel, and partly embedded in a sheath (2) of refractory material protecting the inner tube from contact with the hot molten metal the lance is dipped in. Because the lance is often dipped substantially vertically into the molten metal, the inner tube is anchored to the sleeve in order to prevent the latter from slipping off the inner tube. For example, FIGS. 2&3 of EP-A1-2712938 illustrate anchoring elements distributed all along the inner tube length.

As illustrated in FIG. 2, in use a lance is exposed to severe time dependent thermal gradients in a radial direction between the inner tube mean temperature, T₁, and the refractory sheath mean temperature T₂. For example, when at time, to, a lance is dipped into a molten metal, the whole lance passes from ambient temperature, T_{R}, (or pre-heated temperature) outside the molten metal to the temperature, T_{M}, of the molten metal at the outer surface of the refractory sheath, while the inner tube remains at a relatively low temperature, cooled by the fluid flowing therethrough. During the injection process, the flow rate and composition of the fluid and particles being injected through the inner tube may vary with time, depending on the pre-set injection sequence. The temperature of the inner tube will vary accordingly. Referring to FIG. 2, if the flow rate in the inner tube decreases between times t₁ and t₂, the inner tube temperature, T₁, will increase and, inversely, if the flow rate increases between times t₃ and t₄, or the composition of the fluid is varied yielding a higher thermal conductivity, the temperature, T₁, of the inner tube will decrease accordingly, with further variations of the thermal gradient, ΔT=T₂−T₁, during use; the value of ΔT can reach the order of 1000° C.! When the lance is withdrawn from the metallurgical vessel at time, t₅, the gas flow is generally interrupted and the inner tube temperature, T₁, increases before gradually dropping together with T₂ to room temperature.

The coefficient of thermal expansion of steel can be about two orders of magnitude higher than the thermal expansion coefficient of refractory materials usually used for manufacturing such lances. The difference in coefficients of thermal expansion and the variation of strong temperature gradients generate substantial differences in thermal expansions between the steel inner tube and the refractory sheath material. Since no relative movement between the inner tube and outer refractory sheath is possible at the level of the anchoring elements, substantial shear stresses between the inner tube and the refractory sheath material are created during use. As a consequence, cracks are formed in the refractory material as illustrated in FIG. 3, which shows a degradation sequence with time of the refractory sheath during use. When the cracks give the molten metal access to the inner tube, the lance is definitely out of use.

In order to decrease the cracks in the refractory sheath, DE-U1-29705901 proposes a lance made of a thin inner metal tube in close contact with the refractory sheath reinforced by anchor nodes and a metal rod of a smaller diameter than the inner tube, the rod being centered inside the interior space of the inner metal tube and is welded to the inner metal tube through four protrusions close to the lower end of the metal tube. The rigidity of the lance is conferred by the metal rod. Argon is flushed in the cavity created between the inner tube and the metal rod. As the thickness of the inner tube wall is small, the flushing of the gas cools down the wall and prevents to a certain extent the inner tube from expanding axially. The results are however unsatisfactory because the inner tube is still in close contact with the refractory sheath.

An alternative coupling of the inner tube to the refractory sheath is proposed in GB-A-2107034 allowing a reduction of crack formation compared with traditional lances, such as disclosed in EP-A1-2712938 cited supra. An outlet end of the inner tube is provided with anchoring hooks welded around the circumference of the inner tube. The anchoring hooks are embedded in the refractory sheath and prevent the refractory sheath from sliding out of the inner tube. A number of individual (single) coil steel springs are distributed along the rest of the embedded portion of the inner tube to stabilize the inner tube inside the refractory sheath. Whilst the anchoring hooks are fixedly attached to the tube, the coil steel springs afford axial movement of the tube relative to the coil springs. The coils of the springs are a close fit on the inner tube so that they grip the tube which is thus maintained in its axial position. Radially extending members are provided by the free ends of each spring coil and are embedded in the refractory material of the sheath. They can act as levers to assist in splaying the turns of a coil and thus enable a spring to be moved freely into position along the length of the tube and, upon release, the coil is retracted and the spring firmly grips the inner tube.

In a preferred embodiment of the lance disclosed in GB-A-2107034, a sleeve of insulating material, such as ceramic fibers in a bonding matrix, is provided between the tube and the refractory sleeve, either as a sleeve of material extending continuously along the length of the tube or as a series of shorter sleeves extending between the anchoring means. Alternatively, cardboard or other combustible material sleeves can be provided between the refractory sleeve and the tube. During use of the lance, the cardboard or other material will burn away to form an air gap between the refractory sleeve and the tube.

The concept proposed in GB-A-2107034 of providing an inner tube with fixed anchors located solely at the outlet end of the inner tube, and a series of sliding anchors distributed over the remaining length of the inner tube is theoretically interesting as it allows the steel of the inner tube and the refractory material of the sheath to expand relatively freely from one another in response to temperature gradient variations, without building up any substantial shear stresses. The reduction to practice of said concept as disclosed in GB-A-2107034, however, is far from satisfactory for the following reasons. The coils of the springs are already close fit on the inner tube before casting the refractory material of the sheath. When the refractory sheath is formed and set, the coil springs are embedded in said refractory material and the extending members thereof cannot move anymore to splay the coil of the spring. Upon use, the temperature, T1, of the inner tube and coil springs will raise and will thus expand radially. The coil springs, on the other hand cannot expand more than allowed by their being embedded in the refractory material. It follows that the grip of the coil springs on the inner tube becomes so tight that in practice no movement of the inner tube is possible anymore with respect to the refractory sheath. Consequently substantial shear stresses build up as in traditional lances, leading to early crack formation.

There therefore remains a need for a lance for injecting a fluid into a metallurgical vessel which is more resistant to crack formation than henceforth achieved. The present invention proposes a solution to this problem with a novel and original concept of lance design. These and other advantages of the present invention are described with more details in the following.

### BRIEF SUMMARY OF THE INVENTION

The present invention is defined in the attached independent claims. Preferred embodiments are defined in the dependent claims. In particular, the present invention concerns a lance for top injection of a fluid or particulate material in metallurgical vessels, wherein the lance comprises:
(a) an inner tube, which is hollow and made of metal, and extending over a length, L, along a longitudinal direction, X1, from an inlet end to a tube end, defining a fluid flow path from the tube inlet to a gas outlet located at or adjacent to the tube end,
(b) a sheath of refractory material surrounding the inner tube from the tube end over a length, L1≦L, of the inner tube,
(c) an anchoring point rigidly coupled to said inner tube at an anchor level, and at least partially embedded in the refractory sheath, preventing any movement of the inner tube at the anchor level relative to the refractory sheath in the longitudinal direction, X1,
(d) an annular gap separating the inner tube from the refractory sheath over a length, Lg, which is at least 50% of L1;
(e) at least one annular guide surrounding the inner tube and located within the length, Lg, of the annular gap, said annular guide comprising:
   an annular portion having an inner surface and an outer surface, the inner surface facing and circumscribing the inner tube, and
   at least two anchor protrusions rigidly extending transversally from the outer surface of the annular portion and at least partially embedded in the refractory sheath, wherein a guide gap is formed between at least 50% of the inner surface of the annular portion and an outer surface of the inner tube allowing the movement of the inner tube with respect to the annular guide along the longitudinal direction, X1
      wherein, said at least two anchor protrusions are distributed over the external surface of the annular portion, separated from one another by an angle comprised between 90° and 270° measured from the centroid of the annular portion and between the contact points of the two anchor protrusions with the outer surface of the annular portion of the annular guide.

In some cases, a thermally degradable material, mechanically removable material, and/or thermally removable material can be present in the annular gap. In some cases, a material selected from any of thermally degradable material, mechanically removable material, thermally removable material, and a combination of any of these materials can be present in the annular gap. This is the case if the lance has not been exposed to high temperatures or mechanical stresses sufficient to remove all such materials from around the inner tube. For example if a lance has not been fired and has not been used in a metallurgical vessel, the whole volume of the annular gap will be filled with such material. Alternatively, after use of a lance, temperature conditions may not have been sufficient to remove the whole of said materials, leaving some fragments in the annular gap. The same may apply to the outer surface of the annular portion and/or some portions of the anchor protrusions which may be at least partially covered with a layer of thermally degradable or thermally removable sheet material.

The maximum width of the annular gap may be from and including 0.5 mm to and including 15 mm, from and including 1 mm to and including 10 mm, or from and including 2 mm to and including 5 mm. The annular gap may be homogeneous over the whole circumference of the inner tube, and such result is generally achieved with production methods as described below. But since the inner tube may move in the radial direction within the space defining the annular gap, it cannot be assured that the inner tube will always remain co-axial with the annular gap. In order to restrict the freedom of movement of the inner tube within the annular gap, annular guides can be used. To fulfil this function, the guide gap defined between the inner surface of the annular portion of an annular guide and the outer surface of the inner tube may be smaller than or equal to the annular gap. The maximum width of the guide gap may be smaller than the maximum width of the annular gap and may have a value from and including 0.5 mm to and including 10 mm, or from and including 1 mm to and including 5 mm.

The annular portion of the annular guide may form a closed loop Alternatively, the annular portion of the annular guide forms an open loop with a slit of width of not more than 40% of an inner perimeter of the annular portion. The latter configuration can be advantageous in that it requires less material, and in that the inner diameter of the annular portion can be resiliently varied by increasing or decreasing the width of the slit.

In many lances, an outlet portion of the inner tube adjacent to and including the tube end is coupled to one or more outlet tubes extending from the inner tube, through the refractory sheath to the gas outlet(s) bringing an inner bore of the inner tube in fluid communication with the exterior of the lance. This design allows to orient the flow(s) of gas and/or particles in different directions, and reduces exposure of the inner tube to the high temperatures of the metallurgical vessel.

A single anchoring point may be coupled to said inner tube, to give freedom to most of the embedded length of the inner tube to move longitudinally with respect to the refractory sheath when exposed to temperature gradients. In case several anchoring points are distributed along the length of the inner tube surrounded by the refractory sheath, it is necessary that the coupling locations to the inner tube of the two anchoring points most remote from one another in the longitudinal direction, X1, are separated by a distance, L0, wherein L0≦5.5 10⁻⁶/α [m], wherein α is the coefficient of thermal expansion of the inner tube. In all cases it is necessary that the distance, L0, is in any case not greater than 50 cm.

The single anchoring point or the one of several anchoring points located furthest from the inlet end may be coupled to the inner tube at a location at or adjacent to the tube end. This configuration is advantageous for the following reasons. It is well known that refractory materials have better resistance in compression than in tensile mode. Since the lance is generally held in working position by clamping a top portion of the inner tube jutting out of the refractory sheath, in use the weight of the refractory sheath located upstream from the anchor point rests on the anchoring point and is being compressed. The portion of refractory exposed to tensile stresses is the portion extending downstream from the anchoring point. By locating the anchoring point near the tube end of the inner tube, most of the refractory material is located upstream from the anchoring point and is compressed, whilst the portion of refractory material located downstream of the anchoring point, exposed to tensile stresses generated by its own weight is substantially smaller (and lighter).

The anchor protrusions may comprise two portions transverse to each other. For example they can define a T-shape, V-shape, X-shape, or Y-shape in order to create a strong anchor in the refractory sheath.

The present invention also concerns a process for manufacturing a lance as defined above, comprising the following steps:
(a) Providing an inner tube of length L, defined by an outer surface and comprising a tube end and an anchoring point rigidly coupled to said outer surface positioned at a distance, La, from the tube end, with La≦L;
(b) Inserting a first tubular spacer made of a thermally degradable material, a mechanically removable material, and/or a thermally removable material over the inner tube (the tubular spacer may be made of any of thermally degradable material, a mechanically removable material, a thermally removable material over the inner tube, and a combination of any of these materials);
(c) Inserting an annular guide having at least two anchoring protrusions over the inner tube until it rests on an edge of the first tubular spacer,
(d) Repeating steps (b) and (c) until the desired number of annular guides is reached and until the cumulated length of tubular spacers and annular guides equals or is greater than the desired length, Lg, of the annular gap;
(e) Providing a casting mould having a length greater than or equal to L1
(f) Positioning the thus formed inner tube into said mould with the tube end within said mould,
(g) Casting a refractory material into the mould embedding the thus formed inner tube and at least a portion of the anchoring protrusions of the annular guides, thus forming a sheath of refractory material of length, L1 wherein Lg≧½ L1;
(h) Drying at least partially the refractory material.

A lance as defined above can also be produced by an alternative process comprising the following steps:
(a) Providing an inner tube (1) of length L, defined by an outer surface and comprising an outlet end (1d) and an anchoring point (4) rigidly coupled the said outer surface and comprised within a distance L1 from the outlet end (1d), with L1≦L;
(b) Wrapping the outer surface of the inner tube (1) with a thermally degradable, a mechanically removable material, and/or thermally removable sheet material (11W) of given thickness over a length, Lg, equal to at least 50% of the distance, L1 (the material may be selected from any of a thermally degradable material, a mechanically removable material, a thermally removable sheet material of given thickness over a length, Lg, equal to at least 50% of the distance, L1, and a combination of any of these materials);
(c) Inserting over the sheet wrapped inner tube (1) as many annular guides (5) as desired and spaced apart from one another by a pre-defined distance;
(d) Providing a casting mould of length greater or equal to L1
(e) Positioning the thus wrapped inner tube into said mould with the outlet end within said mould,
(f) Casting the refractory material into the mould embedding the thus formed inner tube and at least a portion of the anchoring protrusions (5P) of the annular guides, thus forming a sheath of refractory material of length, L1;
(g) Drying at least partially the refractory material.

The thermally degradable material or thermally removable material of the tubular spacers or of the sheet material can be thermally degraded or removed and at least partially disappears from the outer surface of the inner tube during either firing of the lance or upon dipping the lance into a metallurgical vessel, such that:
an annular gap is formed between the inner tube and the refractory sheath over a length, Lg, at least equal to 50% of the length, L1, of the refractory sheath allowing the movement along the longitudinal direction, X1, of a portion of the inner tube remote from the anchoring point (4), with respect to the refractory sheath, and
a guide gap is formed over at least 50% of a perimeter of the inner surface of the annular guides allowing the movement of the inner tube with respect to the annular guides along the longitudinal direction, X1.

Either of the two processes defined above may further comprise a step of applying thermally degradable or thermally removable sheet material onto at least a portion of said at least two anchor protrusions and/or of the outer surface of said annular portion of the annular guides. Removal of this material forms a gap allowing for some radial expansion of the annular portion of the annular guides.

In addition to the cracks due to thermal cycles and different expansion coefficients of the refractory sheath and of the inner tube, small cracks resulting from clumsy handling during transportation can occur. Cracks can also be created in the area of the bath level of the molten metal: as the gas flushes in the molten metal bath, the bubbles rise along the lance and burst at the surface of the molten metal bath creating a turbulence. High mechanical forces are generated due to the splashing molten metal, creating new cracks or increasing the size of the existing cracks by the infiltration of molten metal. Sometimes, the radial cracks are very deep and result in the splitting of the refractory sheath into two parts. As the density of the refractory sheath is lower than the density of molten metal, the detached upper part of the sheath floats up as there is no more connection with the inner tube. The inner tube is then no longer protected and enters in contact with the molten metal and eventually melts down. The lower part of the lance is lost in the bath.

In order to prevent any split of the lance in such a case, an advantageous embodiment of the invention comprises a pusher and a blocking element. The blocking element is rigidly coupled to the inner tube in a portion of said inner tube at a distance from the anchor level greater than L1 and the pusher is elastically attached to the blocking element, the pusher being adapted to push the refractory sheath along the direction of the longitudinal axis X1. In another embodiment, the pusher comprises a contact element adapted to contact the surface of the refractory sheath opposite to the anchor level and is attached to the blocking element by one or more resilient elements.

### BRIEF DESCRIPTION OF THE SEVERAL VIEWS OF THE DRAWINGS

FIG. 1 illustrates a lance (a) before introduction into a metallurgical vessel, and (b) after introduction and during injection of a fluid with or without solid particulate material.

FIG. 2 illustrates schematically the mean temperature, T1, of the inner tube and, T2, of the refractory sheath (top graph) and the corresponding temperature gradient, □T=T2−T1, (bottom graph) as a function of utilization time. In both graphs, the abscissa represents the time.

FIG. 3 schematically illustrates a degradation sequence of a lance of the prior art during use.

FIG. 4: illustrates four embodiments of lances according to the present invention.

FIG. 5: illustrates various embodiments of annular guides suitable for the present invention.

FIG. 6: illustrates alternative embodiments of annular guides suitable for the present invention.

FIG. 7: illustrates various positioning of the anchor protrusions about the outer surface of the annular portion of an annular guide.

FIG. 8: illustrates a first embodiment for the production of a lance according to the present invention.

FIG. 9: illustrates a second embodiment for the production of a lance according to the present invention.

FIG. 10: illustrates a cross-section of an annular guide according to two embodiments of the present invention.

FIG. 11: illustrates a preferred embodiment of annular guide provide with centering elements.

FIG. 12: illustrates a preferred embodiment comprising a pusher and a blocking element.

### DETAILED DESCRIPTION OF THE INVENTION

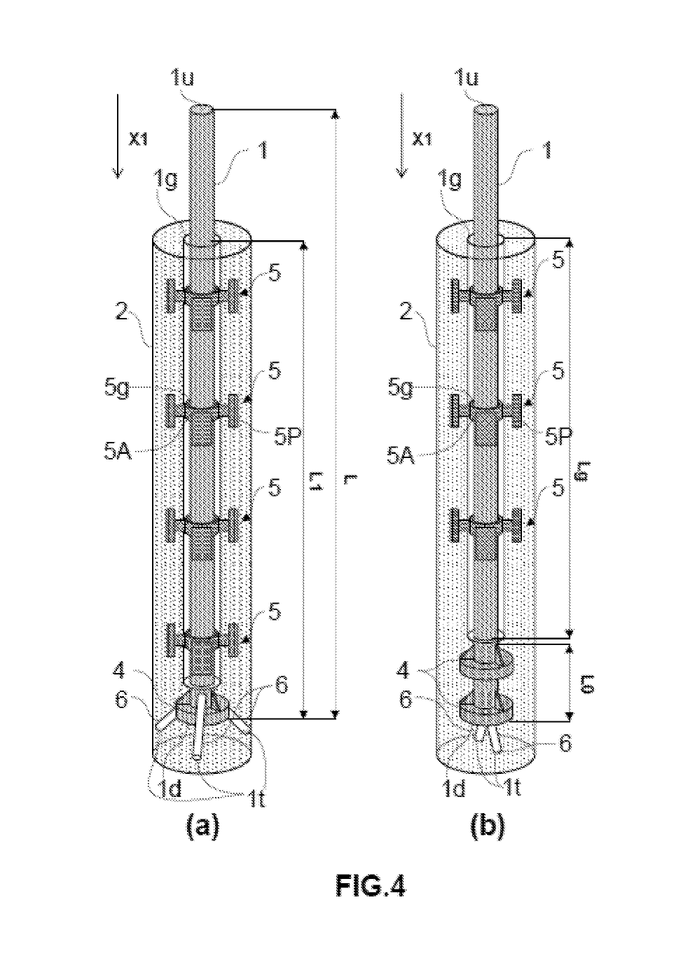

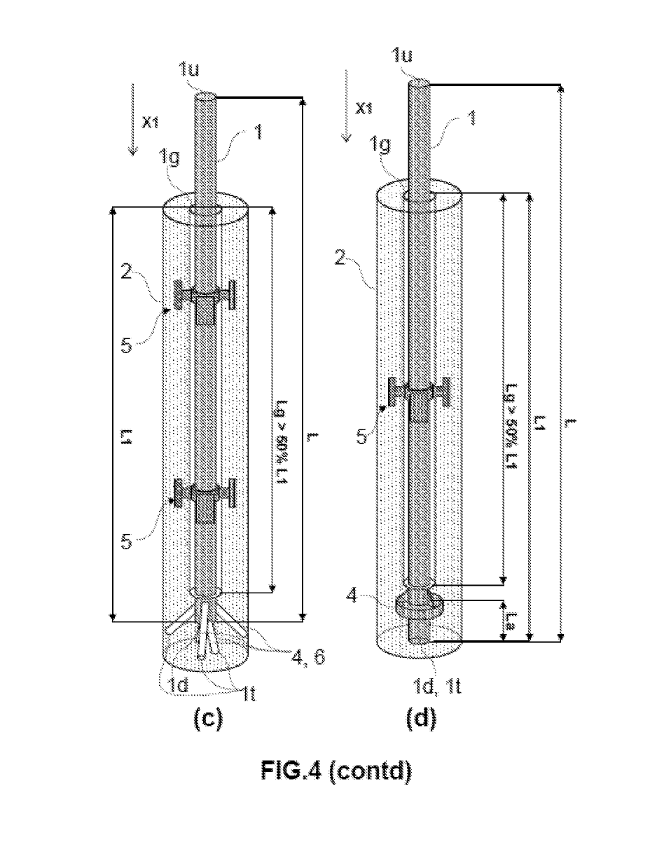

FIG. 4 illustrates various embodiments of a lance according to the present invention. It comprises an inner tube (1), which is hollow and made of metal, generally steel. It extends over a length, L, along a longitudinal direction, X1, from an inlet end (1u) to a tube end (1d), defining a fluid flow path from the tube inlet (1u) to a gas outlet (1t) located at or adjacent to the tube end (1d). The term “gas outlet” is used herein regardless of the nature of the fluid being injected therethrough, whether a fluid or solid particulate material (e.g., gas alone, a mixture of a gas or liquid with solid particles, or a mixture of gas and liquid droplets). The length, L, can be of the order of several meters, typically 0.5 to 10 m, but more generally from 4 to 7 m, and even about 5 to 6 m long. The inner tube is generally albeit not necessarily cylindrical. The outlet (1t) can be coaxial with the longitudinal axis, X1, and may correspond to the tube end (1d), but often the outlet (1t) is composed of one or more smaller channels or tubes (6) extending, not necessarily parallel to X1, from—or adjacent to—said tube end (1d), as discussed e.g., in EP-A1-0802262.

The inner tube (1) is partially embedded in a refractory sheath (2) made of a refractory material surrounding the inner tube (1) from the tube end (1d) over a length, L1≦L, of the inner tube. In use, the refractory sheath (2) protects the inner tube (1) from any contact with molten metal which would inevitably degrade the inner tube due to the high temperature of the molten metal. It acts as an insulating sleeve. Crack formation in the refractory sheath must be prevented as the formation of cracks is detrimental to the insulating function of the sheath. If a crack propagates as far as the inner tube, molten metal may penetrate and contact the inner tube, thus forming a thermal bridge and corresponding high temperature region in the inner tube, which would rapidly degrade the inner tube.

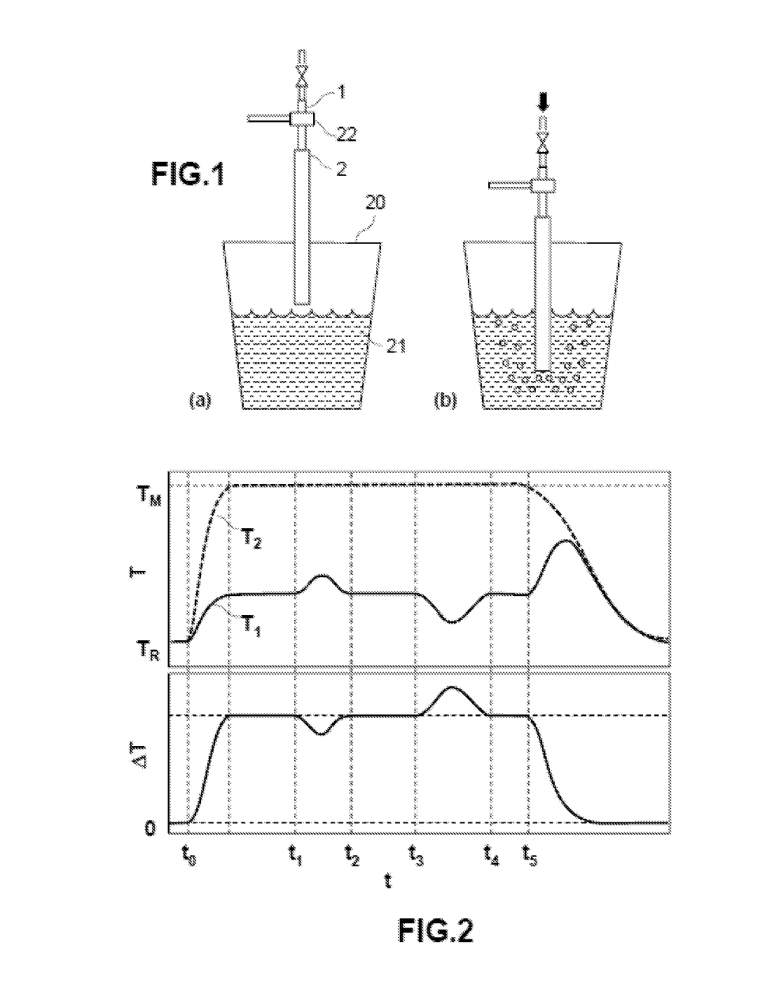

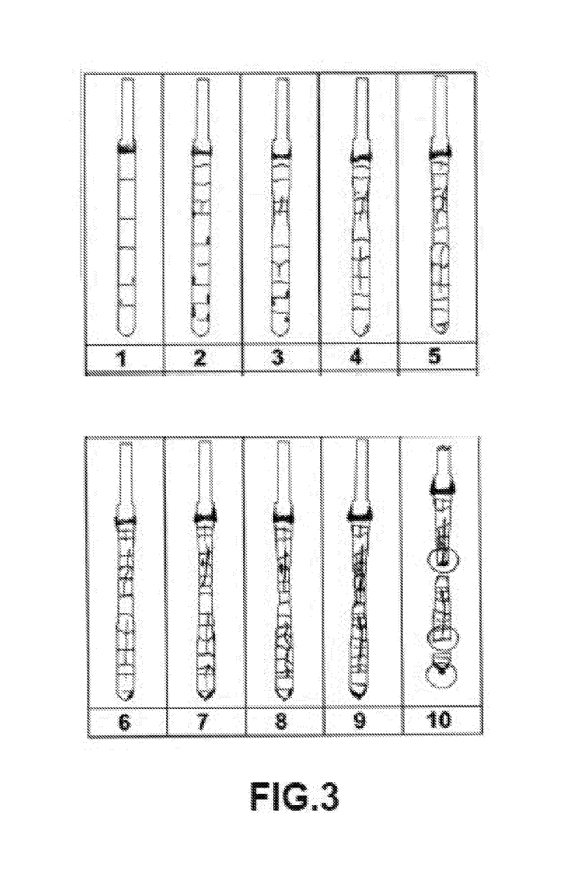

A lance is usually held in substantially vertical operating position with holding means (22) (visible in FIG. 1(a)) gripping a portion of the inner tube jutting out of the refractory sheath. The several meters long refractory sheath therefore hangs freely over a metallurgical vessel. It must therefore be secured to prevent the refractory sheath from slipping off the inner tube and falling into the molten metal. For this reason, an anchoring point (4) is rigidly coupled to said inner tube at an anchor level, and is at least partially embedded in the refractory sheath, to prevent any movement of the inner tube at the anchor level relative to the refractory sheath in the longitudinal direction, X1. In the case in which the outlet (1t) is coaxial with the longitudinal axis and corresponds to the tube end (1d) (cf. FIG. 4(d)), the anchoring level can be located anywhere along the embedded length of the inner tube, such as near the tube end or near an upstream portion of the refractory sheath, wherein “upstream” and “downstream” are defined with respect of the fluid flow.

Often, the outlet (1t) does not correspond to the tube end (1d). The outlet (1t) is then provided at an end of one or more outlet tubes (6) coupled to and extending from the inner tube, through the refractory sheath to an outer surface of the refractory sheath and forming the gas outlet(s) (1t) bringing the inner bore of the inner tube in fluid communication with the exterior of the lance. The outlet tube(s) (6) are located at or adjacent to the tube end (1d). The expression “adjacent to the tube end” is meant here to mean within 10% of L1 from the tube end, not further than 50 cm, or not further than 30 cm from the tube end (1d). If more than one outlet tubes (6) are transverse to the longitudinal axis, X1, and if they are mechanically strong enough, the outlet tubes can act as anchoring points (4) as illustrated in FIG. 4(c). Further examples of outlet tubes or channels which can be used in a lance of the present invention are depicted in EP-A1-0802262.

A single anchoring point (4) is preferred. Several anchoring points (4) can be used, as illustrated in FIG. 4(b), provided all anchoring points are distributed along the length of the inner tube surrounded by the refractory sheath, such that the coupling locations of the two anchoring points most remote from one another are preferably separated by a distance, L0, smaller than 5.5 10⁻⁶/α [m] (L0≦5.5 10⁻⁶/α [m]), wherein a is the coefficient of thermal expansion of the inner tube (1). For example, considering a coefficient of thermal expansion of a steel inner tube of α (steel)=1.0−1.3 10⁻⁵ K⁻¹ [symbol] L0≦5.5 10⁻⁶ m K⁻¹/(1 to 1.3 10⁻⁵ K⁻¹)=0.42−0.5 m. The distance, L0, between the two anchoring points most remote from one another measured in the direction of the longitudinal axis, X1, may have a value not greater than 0.5 m (L0≦0.5 m). With such constraint on the length, L0, of the anchoring level, the refractory sheath can be safely secured to the inner tube and, at the same time, the thermally induced length variations of the anchoring level are negligible in comparison with the thermally induced length variations over the rest of the inner tube.

The single anchoring point (4) or the one of several anchoring points located furthest from the inlet end (1u) may be coupled to the inner tube at a location at or adjacent to the tube end (1d). The case wherein outlet tubes (6) act as anchoring points (4) discussed supra and illustrated in FIG. 4(c) is an example of this embodiment. Alternatively, the single anchoring point (4) or the one of several anchoring points located closest to the inlet end (1u) can be located within 50 cm of the upstream end of the refractory sheath.

The refractory sheath (2) is separated from the inner tube (1) by an annular gap (1g) extending over a length, Lg, which is at least 50% of L1. The maximum width of the annular gap (1g) may be from and including 0.5 mm to and including 15 mm, from and including 1 mm to and including 10 mm or from and including 2 mm to and including 5 mm. The annular gap defined by an outer surface of the inner tube and an opposite inner surface of the refractory sheath, allows said outer surface of the inner tube to move relative to said inner surface of the refractory sheath without generating substantial shear stresses. It follows that it is advantageous to have a gap length, Lg, as long as possible, to reduce the portion of contact between the inner tube and refractory sheath forming an interface in portions of the lance exposed to high thermal gradients. For example, it is advantageous that Lg is at least 60% of the length, L1, of inner tube embedded in (or surrounded by) the refractory sheath (Lg≧0.6 L1), or at least 75% of L1 (Lg≧¾ L1). It should be noted that the term “embedded” is used herein to encompass both the case wherein the inner tube and refractory sheath contact each other forming an interface, and the case wherein they are separated by a gap (1g).

Before firing of the refractory sheath, the annular gap may be filled by a thermally degradable material or thermally removable material. This thermally degradable material or thermally removable material will be discussed more in detail below with respect to the process for producing a lance according to the present invention. In brief, the thermally degradable material or thermally removable material is removed from the annular gap by degradation, melting, vaporization, combustion or dissolution during firing of the refractory sheath, if it applies, or during use in a metallurgical installation (in some cases the refractory sheath is not fired). Even after firing or use, some scraps of said thermally degradable material or thermally removable material may still remain in the annular gap, but at least 80% of the volume of the annular gap should be free of such material during use, in order for a lance according to the present invention to reach its full potential.

The annular gap (1g) together with anchoring points concentrated solely at a single anchor level of length, L0, as discussed above, along the length of the inner tube, allows a movement of the inner tube relative to the refractory sheath over the whole length thereof excluding the anchor level. This geometry as such would, however, be unstable because in use the long portion of tube un-coupled to the refractory sheath (i.e., excluding the anchor level) would vibrate and hit the refractory wall defining the annular gap (1g), thus causing cracks in the refractory material.

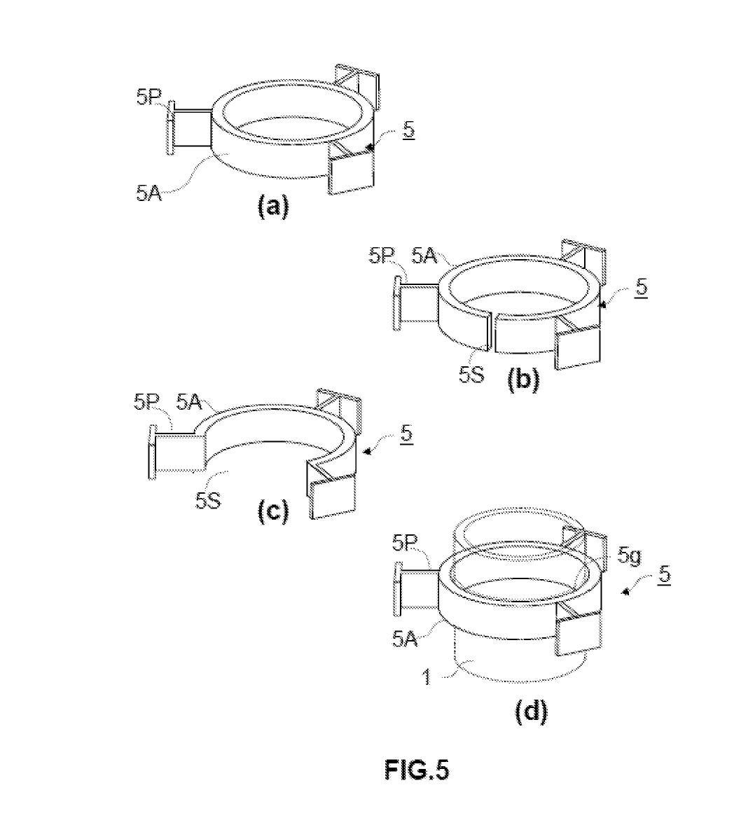

In order to stabilize the lance, it must comprise at least one annular guide (5) surrounding the inner tube and located within the length, Lg, of the annular gap (1g). FIGS. 5 to 7 illustrate embodiments of such annular guides which comprise:
an annular portion (5A) having an inner surface and an outer surface, the inner surface facing and circumscribing the inner tube, and
at least two anchor protrusions (5P) rigidly extending transversally from the outer surface of the annular portion and at least partially embedded in the refractory sheath (2),
   wherein a guide gap (5g) is formed between at least 50% of the inner surface of the annular portion and an outer surface of the inner tube allowing the movement of the inner tube with respect to the annular guide along the longitudinal direction, X1. In practice, it is advantageous that the annular gap (5g) extends over as much of the inner surface as possible. It is advantageous that the guide gap (5g) be formed between at least 70% of the inner surface of the annular portion and the outer surface of the inner tube, over at least 80%, over at least 90%, or over 100% thereof, such that the guide gap (5g) extends over the volume defined between the whole area of the inner surface of the annular portion (5A) and the inner tube (1).

As shown in FIG. 7, the annular guide (5) is characterized in that said at least two anchor protrusions are distributed over the external surface of the annular portion (5A), separated from one another by an angle comprised between 90° and 270° measured from the centroid of the annular portion and between the contact points of the two anchor protrusions (5P) with the outer surface of the annular portion (5A) of the annular guide. As shown in FIG. 7(b), a first and second protrusions (5P1, 5P3) can be separated by an angle smaller than 90° provided there is at least a third protrusion (5P2) which forms with the first protrusion (5P1) an angle comprised between 90 and 270°. Besides anchoring the annular guide as discussed supra, the anchor protrusions (5P) also contribute to the reinforcement of the refractory material forming the sheath. For reinforcement purposes and for homogeneous stress distribution, at least three anchor protrusions per annular guide are advantageous.

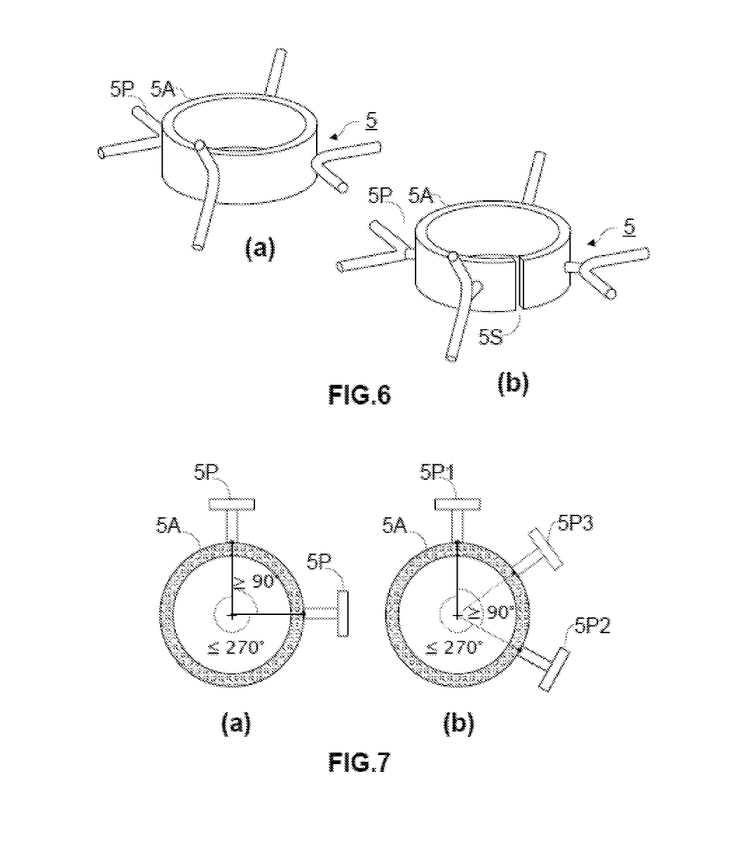

The anchor protrusions can have different geometries, as long as they protrude out of the outer surface of the annular portion (5A) of the annular guide, and can thus be embedded in the refractory material of the sheath. In particular, the anchor protrusions (5P) generally comprise two portions transverse to each other, advantageously defining a T-shape (cf. FIG. 5), V-shape (cf. FIG. 6(a)), Y-shape (cf. FIG. 6(b)), X-shape (not shown), L-shaped (not shown), and the like. The distribution of the at least two anchor protrusions (5P) over the circumference of the outer surface of the annular portion of the annular guide ensures the stability of annular guide with respect to the parallelism of the annular portion (5A) with respect to the longitudinal axis, X1. As long as the annular portion (a) remains substantially parallel to, preferably co-axial with the longitudinal axis, X1, the inner tube (1) can move freely through the annular portion (5A) and with respect to the refractory sheath at the level of said annular guide.

In one embodiment the annular guide is provided with two anchor protrusions (5P) separated from one another by an angle comprised between 90 and 270° (cf. FIG. 7(a)), comprised between 120 and 240°, or by an angle of 180° (i.e., the two protrusions are diametrically opposed). The annular guide can be provided with three anchor protrusions as illustrated in FIGS. 5 and 7(a). It can be provided with four anchor protrusions (5P) as illustrated in FIG. 6. More anchor protrusions may be used, but good results can already be obtained with 2 to 4 anchor protrusions per annular guide (5). Regardless of the number, N, of anchor protrusions (5P), they can always—albeit not necessarily—be distributed evenly around the outer surface of the annular portion (5A), each anchor protrusion being separated from the closest neighbor by an angle of 360°/N (i.e., 180° for N=2 anchor protrusions, 120° for N=3, 90° for N=4, and so on). A distribution of the anchor protrusions (5P) around the perimeter of the annular portion of the annular guides as defined above gives the annular guides a great stability during use, ensuring that they remain substantial co-axial with the inner tube (1). This is not the case, for example, with the free ends of the coil springs disclosed in GB-A-2107034, which extend into the refractory material, because they are located very close to one another anchoring the coil springs at one side only, thus holding the coil springs in cantilever. It follows that a relatively small stress applied onto the coil spring at a location opposite the free ends thereof, e.g., generated by the friction of a thermally expanding inner tube) generates a high torque at the level of the free ends, driving the coil askew with respect to the longitudinal axis, X1. Such torsion of the coil springs generates high stresses in the refractory sheath, concentrated around the area where the free ends are anchored in the refractory material.

By contrast with the lance disclosed in GB-A-2107034, wherein the coil springs are a close fit on the inner tube, in a lance according to the present invention a guide gap (5g) is provided between the inner tube and the annular portion (5A) of the annular guides (5). The guide gap (5g) must be present between at least 50% of the inner surface of the annular portion and an outer surface of the inner tube. Ideally, the guide gap (5g) extends over the whole perimeter of the annular portion (5A) and inner tube (1). The guide gap (5g) ensures that the inner tube can move freely with respect to the annular guide along the longitudinal direction, X1, without generating substantial shear stresses in the refractory material. The maximum width of the guide gap (5g) is preferably smaller than the maximum width of the annular gap (1g). The maximum width of the guide gap (5g) may be comprised from and including 0.5 mm to and including 10 mm, or from and including 1 mm to and including 5 mm.

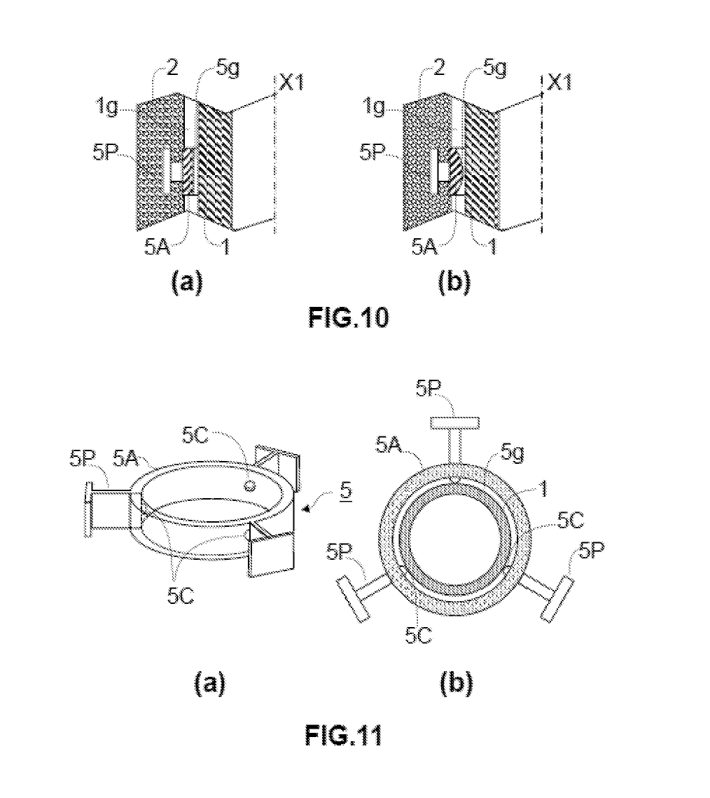

As illustrated in FIGS. 5(a)&(d), 6(a), 7, and 11, the annular portion of the annular guide (5) can form a closed loop. Alternatively, as illustrated in FIGS. 5(b)&(c) and 6(b), the annular portion of the annular guide (5) can form an open loop with a slit (5S) of width of not more than 40% of a perimeter of the annular portion (5A). An annular portion (5A) with a slit (5S) has the advantage that the diameter defined by the annular portion may be increased by opening further the width of the slit upon positioning the annular guides over the inner tube (1). Most inner tubes are cylindrical (or at least comprise cylindrical portions). In this case, the annular guides (5) should define a substantially cylindrical inner surface of the annular portion of diameter, D5, equal to the outer diameter, D1, of the cylindrical (portion of the) inner tube (1) increased by twice the annular gap width, W5, i.e., D5=D1+2 W5. In case of an inner tube having a non-circular cross-section, the inner surface of the annular portion (5A) should define substantially the same cross-section as the inner tube, with dimensions increased to afford the guide gap (5g). The annular portion (5A) generally has a height measured along the direction of the longitudinal axis, X1, which is larger than a thickness measured in the radial direction. For example, the height of an annular portion can be comprised from and including 1.5 mm to and including 25 cm, from and including 5 mm to and including 20 cm, or from and including 7 mm to and including 15 cm. The inner surface of the annular portion (5A) may be defined by a vector parallel to the longitudinal axis, X1, as illustrated in FIG. 10(a). Alternatively, as shown in FIG. 10(b), the inner surface of the annular portion can be curved in the direction of the longitudinal axis, X1. This configuration can help reducing the frictions between inner tube and annular guide in case the latter is misaligned with respect to the longitudinal axis, X1.

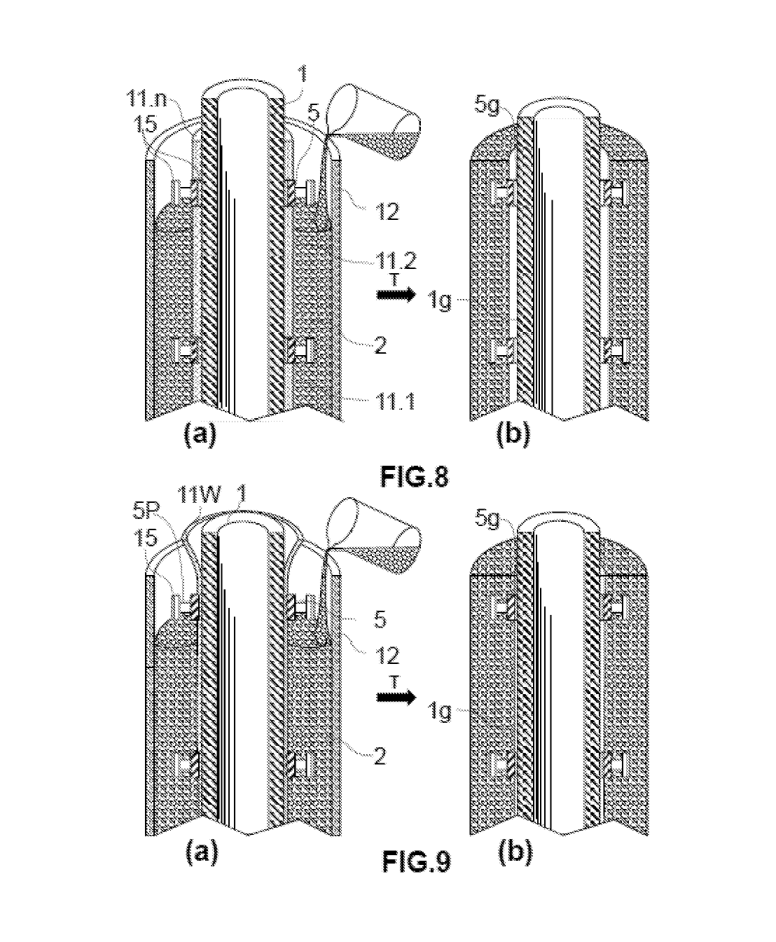

The inner surface of the annular portion (5A) can be provided with at least two, or three (or more) centering elements (5C) illustrated in FIG. 11, protruding radially towards the center of the annular portion and distributed at regular intervals around the perimeter of the inner surface. The centering elements (5C) may have a curved surface. They may protrude out of the inner surface to a distance corresponding to the width of the annular gap (5g). This way, as illustrated in FIG. 11(b) the annular guide maintains a finite number of punctual contacts with the inner tube (1) (three punctual contacts are shown in FIG. 11(b)). This has two advantages. First the width of the annular gap (5g) can be controlled accurately and there is no risk of misalignment between the annular guide and the inner tube provoked (i.e., annular guides remain co-axial with the longitudinal axis, X1), for example, during casting of the refractory material into a casting mould around the inner tube provided with annular guides (cf. e.g., FIGS. 8(a) and 9(a)). Second, during use, the inner tube (1) is prevented from vibrating with an amplitude equal to twice the width of the annular gap (5g), yielding a much more stable lance during injection operations. At the same time, since the contact between the centering elements (5C) and the inner tube is purely punctual, the inner tube is free to vary dimensions as a function of temperature with no hindrance from the annular guides. The centering elements (5C) may be mounted on resilient means or may be made of a resilient material to afford radial expansion of the inner tube.

There can be as few as a single annular guide (5) located at a distance, such as at least L1/2, from the anchoring level, as illustrated in FIG. 4(d). It is advantageous that at least two annular guides (5) are distributed along the length, Lg, of the annular gap (1g), as illustrated in FIG. 4(c). More annular guides (5) yield higher stability of the inner tube over the length, Lg, wherein the portion of refractory sheath comprises the annular gap (1g).

A lance according to the present invention can be produced by a process comprising the following steps, illustrated in FIG. 8:
(a) Providing an inner tube (1) of length L, defined by an outer surface and comprising a tube end (1d) and an anchoring point (4) rigidly coupled to said outer surface positioned at a distance, La, from the tube end (1d), with La L1;
(b) Inserting a first tubular spacer (11.1) made of any of a thermally degradable material, a mechanically removable material, a thermally removable material, and a combination of any of these materials over the inner tube (1);
(c) Inserting an annular guide (5) having at least two anchoring protrusions over the inner tube until it rests on an edge of the first tubular spacer (11.1),
(d) Repeating steps (b) and (c) until the desired number of annular guides is reached and until the cumulated length of tubular spacers and annular guides equals or is greater than the desired length, Lg, of the annular gap (1g);
(e) Providing a casting mould (12) having a length greater than or equal to L1
(f) Positioning the thus formed inner tube into said mould with the tube end within said mould,
(g) Casting a refractory material into the mould embedding the thus formed inner tube and at least a portion of the anchoring protrusions (5P) of the annular guides, thus forming a sheath of refractory material of length, L1 wherein Lg≧½ L1;
(h) Drying at least partially the refractory material.

As shown in FIG. 8(a) it is advantageous to additionally provide a sheet (15) of thermally degradable or a thermally removable sheet material between the inner surface of the annular portion of the annular guides (5) and the outer surface of the inner tube. The sheet (15) allows the centering of the annular portion with respect to the inner tube (1), co-axially with the longitudinal axis, X1. A guide gap (5g) of controlled and substantially constant width throughout the perimeter of the annular portion can thus be obtained. Similarly, the outer surface of the annular portion (5A) and/or some portions of the anchor protrusions (5P) most prompt to create stresses in the surrounding refractory material due to thermal expansion can also be covered with a layer of thermally degradable or thermally removable sheet material (15). Upon degradation or removal of the sheet material a gap is thus created to allow said annular portion and said portions of the anchoring protrusions (5P) to freely expand thermally, in particular radially, without creating stresses responsible for the formation of longitudinal cracks in the refractory material.

This process has the advantage that the width of the guide gap (5g) can be controlled independently of the width of the annular gap (1g). It is preferred that the guide gap (5g) be smaller than the annular gap (1g); so that the annular guides (5) restrict the radial movements of the inner tube but not the longitudinal movements. Another advantage of this process is that by resting on the upper edge of a tubular spacer, an annular guide (5) is maintained in good alignment with the longitudinal axis, X1, although the production process of the lance.

The thermally degradable or thermally removable sheet material can be any material that is combusted at temperatures of the order of 600-1000° C. It may consist of paper or cardboard, a polymer sheet, and the like. The sheet material can also be melted or vaporized at such temperatures. For example a wax or low melting temperature thermoplastic material can be used, such as a polyolefin.

The mechanically degradable material can be any brittle material that will lose mechanical coherence upon application of a shear stress, in particular provoked by the differing thermal variations between the inner tube (1) and the refractory sheath (2) upon exposure to temperature variations during use of the lance.

In an alternative process illustrated in FIG. 9, a lance according to the present invention can be produced with the following steps:
(a) Providing an inner tube (1) of length L, defined by an outer surface and comprising an outlet end (1d) and an anchoring point (4) rigidly coupled the said outer surface and comprised within a distance L1 from the outlet end (1d), with L1≦L;
(b) Wrapping the outer surface of the inner tube (1) with a thermally degradable or thermally removable sheet material (11W) of given thickness over a length, Lg, equal to at least 50% of the distance, L1,
(c) Inserting over the sheet wrapped inner tube (1) as many annular guides (5) as desired and spaced apart from one another by a pre-defined distance;
(d) Providing a casting mould (15) of length greater or equal to L1
(e) Positioning the thus wrapped inner tube into said mould with the outlet end within said mould,
(f) Casting the refractory material into the mould embedding the thus formed inner tube and at least a portion of the anchoring protrusions (5P) of the annular guides, thus forming a sheath of refractory material of length, L1;
(g) Drying at least partially the refractory material.

The thermally degradable or thermally removable sheet material (11W) is preferably compressible in thickness, For example, a corrugated cardboard sheet material can be used or, alternatively a synthetic foam material. In this embodiment, it is preferred to use annular guides (5) with an open loop shaped annular portion, such that the slit (5S) can be increased by application of a circumferential stress when inserting the annular portion through the inner tube wrapped with the compressible sheet material (11W) to increase the breadth of the opening of the annular portion. Upon releasing the stress, the annular portion returns to its nominal diameter which is smaller than the diameter of the inner tube wrapped with the sheet material (11W), such that the compressible sheet material is compressed by the annular portion (5A). After degradation or removal of the sheet material (11W) a guide gap (5g) of width smaller than the width of the annular gap (1g) can thus be obtained.

Regardless of which of the two processes described above and illustrated in FIGS. 8&9 is used for producing a lance according to the present invention, after drying, the refractory material can be fired. All refractory materials do not require firing, but many do. During the firing step the refractory material is sintered and at the same time, the thermally degradable material or thermally removable material of the tubular spacers (11.1, 11.2, 11.n) or of the sheet material (11W) is thermally degraded or removed and at least partially disappears from the outer surface of the inner tube, thus forming:
an annular gap (1g) between the inner tube and the refractory sheath over a length, Lg, at least equal to 50% of the length, L1, of the refractory sheath allowing the movement along the longitudinal direction, X1, of a portion of the inner tube remote from the anchoring point (4), with respect to the refractory sheath, and
a guide gap (5g) over at least 50% of a perimeter of the inner surface of the annular guides allowing the movement of the inner tube with respect to the annular guides along the longitudinal direction, X1.

In case the refractory material does not require firing, the degradation or disappearance of the sheet materials discussed supra may happen during use of the lance for the first time dipped in a bath of molten metal.

The refractory cement is shown in FIGS. 8&9 to be cast from the top into a casting mould (12) held vertically. It is, however, possible to cast the refractory material into a casting mould held horizontally as described in EP2712938. As known in the art, the casting mould can be vibrated during casting and setting of the refractory material.

With the present invention a lance for injecting a fluid with or without a solid particulate material into a metallurgical vessel filled with molten metal has a substantially longer service life than henceforth achievable. In spite of the severe thermal cycles a lance undergoes during its use, the shear stresses mainly due to thermal dilatation mismatches between the metal inner tube and refractory sheath are avoided, thus maintaining the refractory material integrity for a longer time, which can thus protect the inner tube.

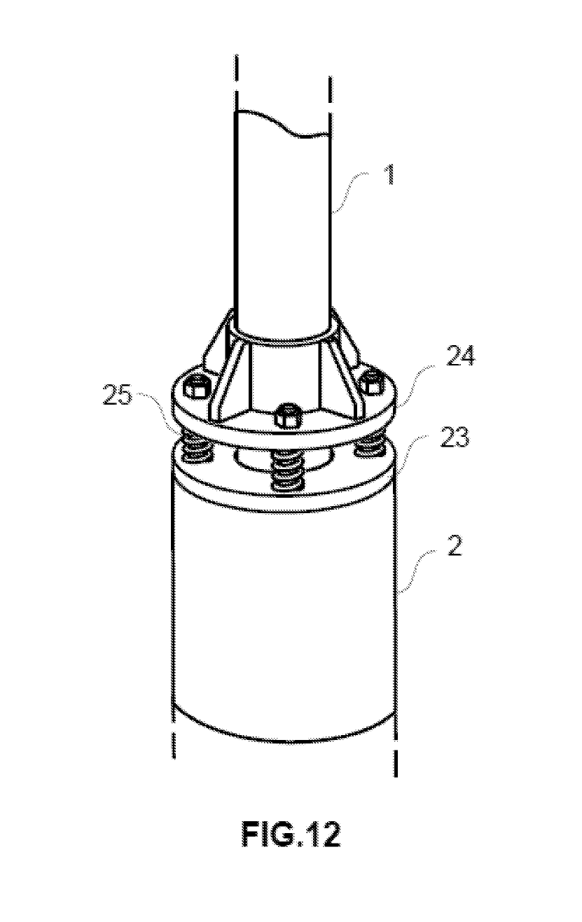

FIG. 12 illustrates a lance comprising a pusher (23) and a blocking element (24). When a crack is deep enough to radially split the refractory sheath into two parts, the upper part of the refractory sheath (2) is retained thanks to the presence of the pusher (23) e.g. a steel plate which is maintained on the upper surface of the refractory sheath by resilient elements such as pre-stressed springs (25) set between the pusher (23) and the blocking element (24) e.g. a steel plate welded on the inner tube (1). In case of axial expansion of the inner tube-occurring for instance when the gas is switched off, the blocking element (24) shifts vertically with the inner tube. Thanks to the pre-stressed springs (25), the pusher (23) remains in place and prevents any axial movement of the upper part of the refractory sheath (2).

Numerous modifications and variations of the present invention are possible. It is, therefore, to be understood that within the scope of the following claims, the invention may be practiced otherwise than as specifically described.

References

| Ref | Description |
|---|---|
| 1 | inner tube |
| 1d | inner tube end |
| 1g | annular gap between inner tube and refractory sheath |
| 1t | Outlet |
| 1u | inlet end of the inner tube |
| 2 | Sheath refractory material |
| 4 | anchoring point |
| 5 | annular guide |
| 5A | annular portion of the annular guide |
| 5C | Centering element |
| 5g | guide gap between inner tube and inner surface of the annular |
| | guide |
| 5P | protrusion rigidly extending out of the outer surface of an |
| | annular guide |
| 5S | slit opening the loop formed by the annular portion 5A |
| 6 | Outlet tube/channel |
| 11W | thermally degradable sheet material |
| 11.1, | tubular spacer |
| 11.2, . . . | |
| 12 | casting mould |
| 15 | thermally degradable sheet material for annular guides (5) |
| 20 | metallurgical vessel |
| 21 | molten metal |
| 22 | holding means for holding lance |
| L | length of inner tube (1) |
| L0 | length of anchoring level |
| L1 | length of inner tube embedded in/surrounded by sheath (2) |
| Lg | length of annular gap (1 g) |
| La | Distance between the tube end (1 d)and the anchoring point (4) |
| T_{M} | molten metal temperature |
| T_{R} | room temperature |
| T₁ | radially mean temperature of the inner tube (1) |
| T₂ | radially mean temperature of the refractory sheath (2) |
| X1 | Longitudinal axis |
| 23 | Pusher |
| 24 | Blocking element |
| 25 | Springs |

1-15. (canceled)

16. Lance for top injection of a fluid or particulate material in metallurgical vessels, wherein the lance comprises:
(a) an inner tube, which is hollow and made of metal, and extending over a length, L, along a longitudinal direction, X1, from an inlet end to a tube end, defining a fluid flow path from the tube inlet to a gas outlet located at or adjacent to the tube end,
(b) a sheath of refractory material surrounding the inner tube from the tube end over a length, L1≦L, of the inner tube,
(c) an anchoring point rigidly coupled to said inner tube at an anchor level, and at least partially embedded in the refractory sheath, wherein the inner tube at the anchor level is immovable in the longitudinal direction, X1, relative to the refractory sheath,
(d) an annular gap separating the inner tube from the refractory sheath over a length, Lg, which is at least 50% of L1;
(e) at least one annular guide surrounding the inner tube and located within the length, Lg, of the annular gap, said annular guide comprising:
an annular portion having an inner surface and an outer surface, the inner surface facing and circumscribing the inner tube, and
at least two anchor protrusions rigidly extending transversally from the outer surface of the annular portion and at least partially embedded in the refractory sheath,
wherein a guide gap is formed between at least 50% of the inner surface of the annular portion and an outer surface of the inner tube allowing the movement of the inner tube with respect to the annular guide along the longitudinal direction, X1,
wherein said at least two anchor protrusions are distributed over the external surface of the annular portion, separated from one another by an angle comprised between 90° and 270° measured from the centroid of the annular portion and between the contact points of the two anchor protrusions with the outer surface of the annular portion of the annular guide with the proviso that, when the lance comprises several anchoring points distributed along the length of the inner tube surrounded by the refractory sheath, the coupling locations to the inner tube of the two anchoring points most remote from one another in the longitudinal direction X1, are separated by a distance, L0, wherein L0≦5.5 10−6/α [m], wherein α is the coefficient of thermal expansion of the inner tube, and wherein the distance, L0, is in any case not greater than 50 cm.

17. Lance according to claim 16 wherein a material selected from the group consisting of thermally degradable material, mechanically removable material, thermally removable material and a combination of any of these materials is present in the annular gap.

18. Lance according to claim 16, wherein the maximum width of the annular gap has a value from and including 0.5 mm to and including 15 mm.

19. Lance according to claim 16, wherein the maximum width of the guide gap is smaller than the maximum width of the annular gap.

20. Lance according to claim 16, wherein the annular portion of the annular guide forms a configuration selected from the group consisting of a closed loop and a configuration wherein the annular portion of the annular guide forms an open loop with a slit of width of not more than 40% of an inner perimeter of the annular portion.

21. Lance according to claim 16, wherein an outlet portion of the inner tube adjacent to and including the tube end is coupled to one or more outlet tubes extending from the inner tube, through the refractory sheath to the gas outlet(s) bringing an inner bore of the inner tube in fluid communication with the exterior of the lance.

22. Lance according to claim 16, comprising a single anchoring point coupled to said inner tube.

23. Lance according to claim 22, wherein the single anchoring point or the one of several anchoring points located furthest from the inlet end is coupled to the inner tube at a location at or adjacent to the tube end.

24. Lance according to claim 16, wherein the anchor protrusions comprise two portions transverse to each other.

25. Lance according to claim 16, wherein at least a portion of the anchor protrusions and the outer surface of the annular portion is at least partially covered with a layer of thermally degradable or thermally removable sheet material.

26. Process for manufacturing a lance according to claim 16, comprising the following steps:
(a) Providing an inner tube of length L, defined by an outer surface and comprising a tube end and an anchoring point rigidly coupled to said outer surface positioned at a distance, La, from the tube end, with La≦L;
(b) Inserting a first tubular spacer made of a material selected from the group consisting of thermally degradable material, a mechanically removable material, a thermally removable material over the inner tube, and a combination of any of these materials,
(c) Inserting an annular guide having at least two anchoring protrusions over the inner tube until it rests on an edge of the first tubular spacer,
(d) Repeating steps (b) and (c) until the desired number of annular guides is reached and until the cumulated length of tubular spacers and annular guides equals or is greater than the desired length, Lg, of the annular gap;
(e) Providing a casting mould having a length greater than or equal to L1
(f) Positioning the thus formed inner tube into said mould with the tube end within said mould,
(g) Casting a refractory material into the mould embedding the thus formed inner tube and at least a portion of the anchoring protrusions of the annular guides, thus forming a sheath of refractory material of length, L1 wherein Lg≧½ L1;
(h) Drying at least partially the refractory material.

27. Process for manufacturing a lance according to claim 16, comprising the following steps:
(a) Providing an inner tube of length L, defined by an outer surface and comprising an outlet end and an anchoring point rigidly coupled the said outer surface and comprised within a distance L1 from the outlet end, with L1≦L;
(b) Wrapping the outer surface of the inner tube with a material selected from the group consisting of a thermally degradable material, a mechanically removable material, a thermally removable sheet material of given thickness over a length, Lg, equal to at least 50% of the distance, L1, and a combination of any of these materials;
(c) Inserting over the sheet wrapped inner tube as many annular guides as desired and spaced apart from one another by a pre-defined distance;
(d) Providing a casting mould of length greater or equal to L1
(e) Positioning the thus wrapped inner tube into said mould with the outlet end within said mould,
(f) Casting the refractory material into the mould embedding the thus formed inner tube and at least a portion of the anchoring protrusions of the annular guides, thus forming a sheath of refractory material of length, L1;
(g) Drying at least partially the refractory material.

28. Process according to claim 26 wherein the thermally degradable material or thermally removable material of the tubular spacers or of the sheet material is thermally degraded or removed and at least partially disappears from the outer surface of the inner tube during either firing of the lance or upon dipping the lance into a metallurgical vessel, such that:
an annular gap is formed between the inner tube and the refractory sheath over a length, Lg, at least equal to 50% of the length, L1, of the refractory sheath allowing the movement along the longitudinal direction, X1, of a portion of the inner tube remote from the anchoring point, with respect to the refractory sheath, and
a guide gap is formed over at least 50% of a perimeter of the inner surface of the annular guides allowing the movement of the inner tube with respect to the annular guides along the longitudinal direction, X1.

29. Process according to claim 26, further comprising the application of thermally degradable or thermally removable sheet material onto at least a portion of said at least two anchor protrusions and/or of the outer surface of said annular portion of the annular guides.

30. Lance according to claim 16, further comprising a pusher and a blocking element wherein the blocking element is rigidly coupled to the inner tube in a portion of said inner tube at a distance from the anchor level greater than L1 and the pusher is elastically attached to the blocking element, the pusher being adapted to push the refractory sheath along the direction of the longitudinal axis X1.
